(19) United States
(12) Patent Application Publication
(10) Pub. No.: US 2018/0039744 A1
(43) Pub. Date: Feb. 8, 2018

(54) AUTOMATED PAYMENT SYSTEM

(71) Applicants: James B. Nusbaum, Sylvania, OH (US); Scott Kalniz, Sylvania, OH (US); Derek Tefft, Sylvania, OH (US)

(72) Inventors: James B. Nusbaum, Sylvania, OH (US); Scott Kalniz, Sylvania, OH (US); Derek Tefft, Sylvania, OH (US)

(21) Appl. No.: 15/666,895

(22) Filed: Aug. 2, 2017

Related U.S. Application Data
(60) Provisional application No. 62/369,811, filed on Aug. 2, 2016.

(51) Int. Cl. G06F 19/00

(52) U.S. Cl. CPC G06F 19/328; G06F 3/0482

(57) ABSTRACT

A system of automated payment from a patient to a healthcare provider includes a host including a memory and a processor. A plurality of communication devices are in communication with the host. A patient interface associated with a patient is downloadable on a first one of the plurality of communication devices. The patient interface includes a payment account information of the patient and is configured to distribute to the host the payment account information. A provider interface associated with a healthcare provider providing healthcare to the patient is downloadable on a second one of the plurality of communication devices. The provider interface is configured to receive the payment account information of the patient from the host to process a payment at the time of service for services provided to the patient from the healthcare provider.

### CROSS-REFERENCE TO RELATED APPLICATIONS

This patent application claims the benefit of U.S. Provisional Patent Application Ser. No. 62/369,811, filed on Aug. 2, 2016. The entire disclosure of the above patent application is hereby incorporated herein by reference.

### FIELD OF INVENTION

The invention relates generally to a system and method for providing an automated payment to a healthcare provider contemporaneous with a rendering of goods or services.

### BACKGROUND

Paying for medical care at the time of service is one of the few business transactions in the United States which consumers (i.e. patients) think is appropriate not to pay for their out-of-pocket responsibility at the time of service provided by a healthcare provider. This is tantamount to going to the grocery store, at the checkout line only paying for 75% of what you bought, and then telling the grocery store to bill you for the remaining 25%.

The collection of out-of-pocket expenses from patients during the time of service has been and continues to be a laborious process for healthcare providers, and costs the healthcare providers across the United States billions of dollars every year in uncompensated care. The Medical Group Management Association (MGMA) performed a survey in 2010, Perspectives on Patient Payments, and the results showed that 23.2% of total patient services revenue is attributed to collection from the patients. The survey showed that 30% of the patients walk out of an office of the healthcare provider without paying any money, and the healthcare provider will send an average of 3.3 billing statements before an outstanding balance of the patient is paid in full. The collection results are even worse, wherein the healthcare provider will recover just $15.77 for every $100 owed once a debt of the patient is turned over to collections. For every 30 days that go by without the patient paying their medical bills, the healthcare provider is 30% less likely to collect any money from the patient.

For the collection of out-of-pocket expenses at the healthcare provider, the same process has been in place since the 1980s. While the healthcare providers have attempted to create solutions in the patient revenue collection process at the time of service (i.e. deny access to medical services until the bill is paid, set up payment plans, accept multiple forms of payment) the process continues to be an uncomfortable process for both the patients and the healthcare providers, and burdensome for the healthcare provider practice groups and collection agencies. For example, physicians do not always collect copayments at the time of service because they are unaware of copayments or are simply uncomfortable asking the patient, the patients are unaware or unsure of their copayment responsibility, or copayment information is not always available at the time of the service.

While health plans, both commercial and public, continue to shift more costs to the patients, the collection of out-of-pocket costs will continue to be a tremendous problem for the healthcare providers across the entire United States and is likely to escalate as the shift continues. Centers for Medicare and Medicaid Services National Health Projections 2012-2022 projects out-of-pocket spending to grow faster over the remainder of the projection period (2012-2022), reaching a peak of 5.6 percent in 2020. The out-of-pocket share of healthcare spending is projected to fall from 11.4 percent in 2012 to 9.1 percent by 2022. These projections show the process to collect out-of-pocket expenses is far too important to be handled under the current processes in place used by healthcare providers.

The Commonwealth Fund published a report in 2015 detailing the total dollars spent yearly on out-of-pocket costs including copayments, deductibles, coinsurance, and uncovered services.

TABLE 1
Out-of-Pocket Expenditures, 2013 and 2014

| | | Percent of | | Percent of | | |
|---|---|---|---|---|---|---|
| | 2013 | Total | 2014 | Total | 2013 | 2014 |
| | Amount | OOP | Amount | OOP | Growth | Growth |
| | (Millions) | 2013 | (Millions) | 2014 | Rate | Rate |
| Total National | $325,487 | 100% | $329,819 | 100% | 2.1% | 1.3% |
| Out-of-Pocket (OOP) | | | | | | |
| Expenditures | | | | | | |
| Physician and Clinical | 53,869 | 16.6 | 54,035 | 16.4 | 2.6 | .3 |
| Non-Durable Medical | 52,884 | 16.2 | 54,865 | 16.6 | 4.8 | 3.4 |
| Products | | | | | | |
| Dental | 45,638 | 14.0 | 45,726 | 13.9 | 1.0 | .2 |
| Prescription Drug | 43,547 | 13.4 | 44,722 | 13.6 | −3.7 | 2.7 |
| Nursing Care | 40,786 | 12.5 | 41,159 | 12.5 | 1.6 | .9 |
| Hospital | 32,712 | 10.1 | 31,373 | 9.5 | 4.7 | −4.1 |
| Durable Medical | 22,976 | 7.1 | 23,592 | 7.2 | 3.5 | 2.7 |
| Equipment | | | | | | |
| Other Professional Services | 20,390 | 6.3 | 21,292 | 6.5 | 2.5 | 4.4 |
| Home Health Care | 6,908 | 2.1 | 7,369 | 2.2 | 5.7 | 6.7 |
| Other Care | 5,778 | 1.8 | 5,867 | 1.8 | 8.2 | 1.5 |

Examining the Physician and Clinical services of Table 1, taking 30% of $54 billion, about $16.2 billion annually is the total dollar amount of unpaid healthcare services. Factoring in all service lines under the Total National Out-of-Pocket (OOP) Expenditures and applying the 30% factor to this figure equals about $98.9 billion annually in dollars not collected at the time of service by the healthcare providers

In April 2016, the Kaiser Family Foundation reported the breakdown of out-of-pocket costs based on the average dollars spent per enrollee per year for deductibles, copayments, and coinsurance. The results showed that 14.5% of total healthcare spending per enrollee was attributable to out-of-pocket costs in 2014. Deductibles represented 6.8%, copayments represented 3.0%, and coinsurance represented 4.7% of total healthcare spending per enrollee. The breakdown of the total out-of-pocket costs per enrollee shows that deductibles represent 46.9% of the total out-of-pocket costs, copayments represent 20.7% of total out-of-pocket costs, and coinsurance represents 32.4% of total out-of-pocket costs.

The table below outlines the out-of-pocket expenses attributable to deductibles, copayments, and coinsurance (percentages based on the April 2016 Kaiser Family Foundation Report) based on the 2014 out-of-pocket expenses outlined in Table 1 for the different healthcare providers.

TABLE 2
Out-of-Pocket Expenditures Breakdown by Deductibles,
Co-Pay, and Co-Insurance - 2014

| | | | Co-Pay | Co- |
|---|---|---|---|---|
| | 2014 | Deductibles | (20.7% of | Insurance |
| | Amount | (46.9% of | total | (32.4% of |
| | (Millions) | total OOP) | OOP) | total OOP) |
| Total National Out-of- | $329,819 | $154,686 | $68,272 | $106,861 |
| Pocket (OOP) | | | | |
| Expenditures | | | | |
| Physician and Clinical | 54,035 | 25,343 | 11,185 | 17,507 |
| Non-Durable Medical | 54,865 | 25,732 | 11,357 | 17,776 |
| Products | | | | |
| Dental | 45,726 | 21,446 | 9,465 | 14,815 |
| Prescription Drug | 44,722 | 20,975 | 9,257 | 14,490 |
| Nursing Care | 41,159 | 19,304 | 8,520 | 13,336 |
| Hospital | 31,373 | 14,714 | 6,494 | 10,165 |
| Durable Medical | 23,592 | 11,064 | 4,884 | 7,644 |
| Equipment | | | | |
| Other Professional | 21,292 | 9,986 | 4,407 | 6,899 |
| Services | | | | |
| Home Health Care | 7,369 | 3,456 | 1,525 | 2,388 |
| Other Care | 5,867 | 2,752 | 1,214 | 1,901 |

^{#}Assumption that all providers represent the same percentage of out of pocket expenses based on the April 2016 Kaiser Family Foundation report.

Accordingly, there exists a need in the art for a means of providing seamless and instantaneous payment from a patient to a healthcare provider at the time of service.

### SUMMARY OF THE INVENTION

In concordance with the instant disclosure, a means of providing seamless and instantaneous payment from a patient to a healthcare provider at the time of service is surprisingly discovered.

According to an embodiment of the disclosure, a system of automated payment from a patient to a healthcare provider includes a host including a memory and a processor. A plurality of communication devices are in communication with the host. A patient interface associated with a patient is downloadable on a first one of the plurality of communication devices. The patient interface includes a payment account information of the patient and is configured to distribute to the host the payment account information. A provider interface associated with a healthcare provider providing healthcare to the patient is downloadable on a second one of the plurality of communication devices. The provider interface is configured to receive the payment account information of the patient from the host to process a payment at the time of service for services provided to the patient from the healthcare provider.

According to another embodiment of the disclosure, a method of providing a payment from a patient to a provider is disclosed. The method includes the steps of providing a system including a host having a memory for storing information and a processor. The host is in communication with a plurality of communication devices. A first one of the communication devices has a downloadable patient interface associated with the patient receiving services from the healthcare provider. A second one of the communication devices has a downloadable provider interface associated with the healthcare provider and a third one of the communication devices has a downloadable administrator interface associated with an administrator of the system. The patient interface, the provider interface, and the administrator interface providing real-time communication between the plurality of communication devices. The method further includes the steps of creating a payment account with the patient interface by the patient and transferring the payment with the patient interface to the administrator interface through the host. The method includes the step of transferring the payment to the provider interface from the administrator interface through the host and the step of processing the payment through the provider interface at a time of the services.

According to yet another embodiment of the disclosure, a method of providing a payment from a patient to a provider is disclosed. The steps include providing a system including a host having a memory for storing information and a processor. The host is in communication with a plurality of communication devices. A first one of the communication devices has a downloadable patient interface associated with a patient receiving services from a healthcare provider. A second one of the communication devices has a downloadable provider interface associated with the healthcare provider. A third one of the communication devices has a downloadable administrator interface associated with an administrator of the system. A fourth one of the communication devices has a downloadable insurance interface associated with an insurance provider. The patient interface, the provider interface, the insurance interface, and the administrator interface providing real-time communication between the plurality of communication devices. The method includes the steps of signing up with the system by the patient through the patient interface and creating a payment account with the patient interface by the patient. The method further includes the steps of transferring the payment with the patient interface to the administrator interface through the host, transferring the payment to the healthcare provider interface from the administrator interface through the host, and processing the payment instantaneously through the provider interface at a time of the services.

### BRIEF DESCRIPTION OF THE DRAWINGS

FIG. 1 is a schematic flow diagram illustrating a system of the instant disclosure;

FIG. 2 is a schematic flow diagram illustrating a method of providing payment from a patient to a healthcare provider using the system of FIG. 1, wherein interaction between the patient, the healthcare provider, and an insurance provider with the system is shown;

FIG. 3 is a schematic flow diagram illustrating the method of providing payment from the patient to the healthcare provider using the system of FIGS. 1-2; and

FIG. 4 is a graphical representation which shows a main screen of a patient interface of the system of FIGS. 1-3, to illustrate an underlying functionality thereof.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical unless otherwise expressed.

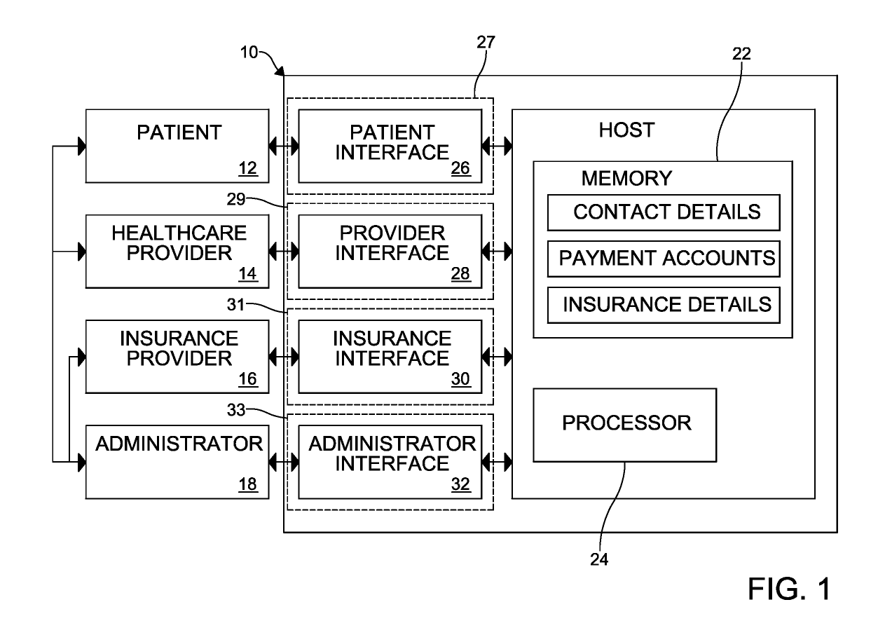

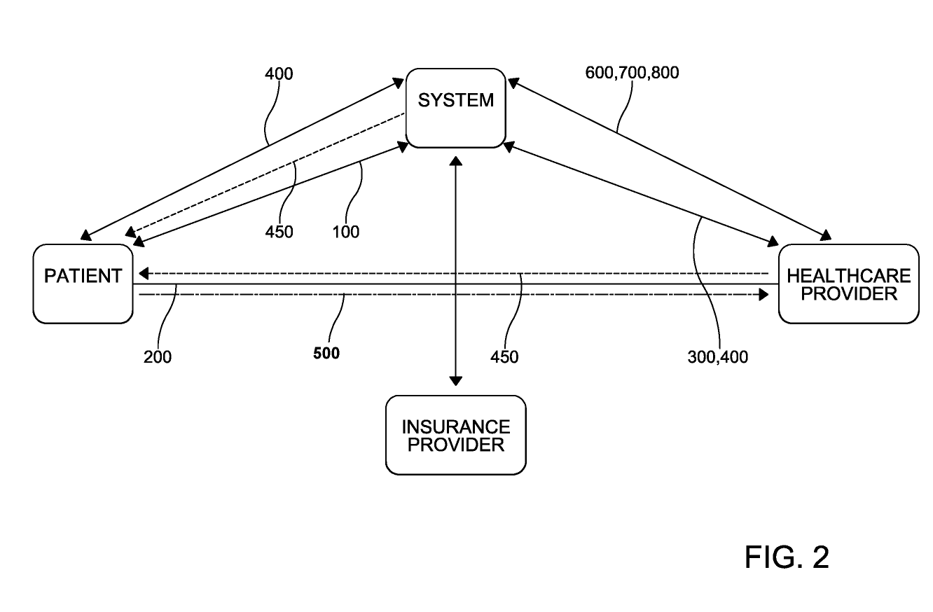

As shown in FIGS. 1-2, a system 10 is provided for facilitating payment and communication between each of a patient 12, a healthcare provider 14, an insurance provider 16, and a system administrator 18. However, it is understood other individuals or group of individuals can be included within the network communication, if desired. For example, administrators, family, and friends of the patient 12 responsible for the patient 12 can be included. In another example, a pharmacist, a medical device provider, or any other individual or group can be included in the network of communication as desired. The system 10 provides payment from the patient 12 to the healthcare provider 14 contemporaneously or instantaneously at the time of service. Payment can be provided to other individuals besides the healthcare provider if desired. As used herein, “at the time of service” means at a time while the patient 12 is within a facility, medical practice, office, or place of business of the healthcare provider 14 or where accounting or collections of costs for services provided to the patient 12 from the healthcare provider 14 are located. For example, “at the time of service” may be a time immediately after the services are rendered by the healthcare provider 14 until not more than sixty minutes after the services are rendered by the healthcare provider 14 such as when the patient 12 is leaving the facility. Additionally, “at the time of service” can further include a time immediately before the services are rendered by the healthcare provider 14 to the patient 12 such as a time between sixty minutes before the services are rendered until the services are rendered such as when the patient 12 is entering the facility and waiting for the services to be rendered. Furthermore, “at the time of service” can include the time period when the services are being rendered by the healthcare provider 14 to the patient 12. It is understood, payment from the patient 12 to the healthcare provider 14 can be accomplished through the system 10 at any time period that is not identified above as at the time of service.

The patient 12 is any person receiving medical care such as preventative, curative, promotional, hospital, or rehabilitative services at a medical provider or medical facility or as otherwise defined in the healthcare community or by the insurance provider 16. The patient 12 may or may not owe the healthcare provider 14 an out-of-pocket cost. As used herein, out-of-pocket costs, payments or expenses refers to payments or expenses not reimbursed by the insurance provider 16, which include deductibles, coinsurance, and copayments for services provided by the healthcare provider 14 covered by the insurance of the patient 12 or costs for all services not covered by the insurance of the patient 12. The healthcare provider 14 is an individual or group of individuals providing preventative, curative, promotional or rehabilitative health care services or any other health care services in a systematic way to individuals, families or communities. The healthcare provider 14 can be any healthcare provider as known to a person skilled in the art. The insurance provider 16 is an individual or group providing various health insurance plans to individuals and families as known to the person skilled in the art. The system administrator 18 is an individual, group, or system responsible for upkeep, configuration, and reliable operation of the system 10, wherein the system administrator 18 can make changes to the system 10 that will affect other users of the system such as the patient 12, the healthcare provider 14, and/or the insurance provider 16. The system administrator 18 is responsible for security settings of the system 10, installing and updating software and hardware, access to information, and troubleshooting, for example.

The system 10 includes a host 20 having a memory 22 and a processor 24. The system 10 further includes a patient interface 26, a provider interface 28, an insurance interface 30, and an administrator interface 32. In certain embodiments, the patient interface 26, the provider interface 28, the insurance interface 30, and the administrator interface 32 are the same or similar interfaces. In other embodiments, the patient interface 26, the provider interface 28, the insurance interface 30, and the administrator interface 32 are different interfaces customized as desired depending on the requirements or personalization of the patient 12, the healthcare provider 14, the insurance provider 16, and the system administrator 18.

In certain embodiments, the interfaces 26, 28, 30, 32 are a downloadable web application or software configured to allow a user to interact with a respective communication device 27, 29, 31, 33. The communication devices 27, 29, 31, 33 can be a smartphone, such as an iPhone® smartphone, a laptop computer, a desktop computer, or a tablet such as an iPad® tablet, for example. However, those skilled in the art would appreciate that the invention can be practiced with other devices and configurations suitable for capturing, sending, and receiving media, including Internet appliances, hand-held devices, wearable computers, multi-processor systems, microprocessor-based or programmable consumer electronics, set-top boxes, PDAs, thin clients, and other devices and configurations as desired. The term “communication device” is intended to include all such devices.

The host 20 is a computer, network, or other device in communication with a network of communication devices and provides resources, services, applications, or other data to the network of communication devices. The host 20 is operated, controlled, and manipulated by the system administrator 18. The host 20 can be a smartphone, such as an iPhone® smartphone, a laptop, a desktop, and a tablet, such as an iPad® tablet. However, those skilled in the art would appreciate that the invention can be practiced with other devices and configurations suitable for capturing, sending, and receiving information, including Internet appliances, web-based software or portals, hand-held devices, “smart” devices, wearable computers, multi-processor systems, microprocessor-based or programmable consumer electronics, set-top boxes, PDAs, cloud computing, thin clients, and other devices and configurations as desired. The term “host” is intended to include all such devices or computing services. It is understood that any number of hosts, databases, and servers may be included, as well as any other components necessary for operation of the system 10. The memory 22 is configured for storing received information or data such as patient details such as contact details, payment accounts, and insurance details, for example. Although, it is understood the memory 22 can be configured to store other information as desired.

The patient interface 26 is configured to allow real-time communication between the patient 12 and the system 10 and thus between the healthcare provider 14 through the provider interface 28, the insurance provider 16 through the insurance interface 30, and the system administrator 18 through the administrator interface 32. The patient interface 26 is in communication with the system 10, wherein the patient 12 can view and edit a plurality of the information such as the patient details stored in the memory 22 in an HIPAA-compliant (i.e. Health Insurance Portability and Accountability compliant) and HTTPS-secured (i.e. Hypertext Transfer Protocol Secure) format which is also PCI DSS (i.e. Payment Card Industry Data Security Standard) compliant. The patient details include insurance details of the patient 12 such as effective date of insurance, insurance group identification number, patient identification number, insurance company name, patient name and date of birth, and dependent name(s) and date(s) of birth, for example. The patient details also include the patient contact details such as phone numbers, mailing and billing address, and email address, for example.

The patient details will also include the payment account information. For example, the payment account information will identify at least one of a checking account, a savings account, a debit card, a credit card, a health savings account, a flex spending account, or similar type accounts now known or later employed. The payment account information will include account identification numbers, bank routing numbers, account expiration dates, and card verification values, wherein the system 10 is configured to authorize and process a payment from one of the respective payment accounts to the healthcare provider 14. The system 10 will also be synchronized with at least one of the payment accounts, wherein the system 10 is in real-time communication with the synchronized payment accounts. For example, the system 10 may be synchronized with a health savings account and a flex spending account, wherein the patient 12 can view a current status of each account. Accordingly, the payment account information may include login credentials for an on-line portal for each synchronized payment account, allowing the system 10 to continuously monitor the on-line portal.

Similarly, the system 10 is in communication with the insurance provider 16 and the insurance interface 30 through the host 20 such as through the user portal, for example, wherein the system 10 allows the patient 12 to view benefits, claim status, deductibles, and/or explanations of benefits through the patient interface 26.

Additionally, the patient interface 26 may include a means for providing patient feedback with respect to the services or goods offered by the healthcare provider 14. The feedback may be provided directly to the healthcare provider 14, or may be collected by the system administrator 18, wherein the system administrator 18 provides feedback to other patients 12 regarding the healthcare provider 14 via the patient interface 26.

The system 10 further includes the provider interface 28 configured to facilitate real-time communication between the healthcare provider 14 and the system 10 and thus between the patient 12 through the patient interface 26, the insurance provider 16 through the insurance interface 30, and the system administrator 18 through the administrator interface 32. The provider interface 28 allows the healthcare provider 14 to access the payment details provided by the patient 12 to the system 10. The provider interface 28 can be set up as a standalone system or can be integrated into a revenue cycle management (RCM) program, electronic medical record (EMR) system, or other system employed by the healthcare provider 14. Through the provider interface 28, the healthcare provider 28 can also access the insurance details of the patient 12, estimate or calculate the out-of-pocket costs of the patient 12, and other information such as contact details or medical or accounting history.

The provider interface 28 of the system 10 may be customizable to accommodate various types of healthcare providers 14, including but not limited to: health systems, multi-specialty medical practices, individual practitioner practices, free standing surgery centers, free standing radiology and laboratory centers, dental practices, therapists, optometry practices, chiropractors, mental health providers, and any other healthcare providers collecting out-of-pocket expenses of the patient 12.

The system 10 further includes the insurance interface 30 configured to facilitate real-time communication between the insurance provider 16 and the system 10 and thus between the patient 12 through the patient interface 26, the healthcare provider 14 through the provider interface 28, and the system administrator 18 through the administrator interface 32. Through the insurance interface 30, the insurance provider 16 can provide, update, and edit the insurance details of the patient 12 such as services covered by the insurance for the healthcare provider 14 and deductible amounts, out-of-pocket costs, and other details as desired.

The system 10 further includes the administrator interface 32 configured to facilitate real-time communication between the system administrator 18 and the system 10 and thus between the patient 12 through the patient interface 26, the healthcare provider 14 through the provider interface 28, and the insurance provider 16 and through the insurance interface 30. Through the administrator interface 32, the system administrator 18 can configure, edit, troubleshoot, customize, or otherwise manipulate the system 10 that will affect other users of the system 10 such as the patient 12, the healthcare provider 14, and/or the insurance provider 16.

Accordingly, each of the patient 12, the healthcare provider 14, and the insurance provider 16 may be in simultaneous real-time communication with the system 10, thereby providing indirect real-time communication between each of the patient 12, the healthcare provider 14, and the insurance provider 16 wherein information stored in the memory 22 is instantly available to any one of the parties. However, the system 10 may also include a real-time messaging application, such as instant messaging means or a video messaging application, or other messaging means, such as e-mail, wherein the patient 12 can communicate with any one of the healthcare provider 14, the insurance provider 16, and the system administrator 18 through the system 10.

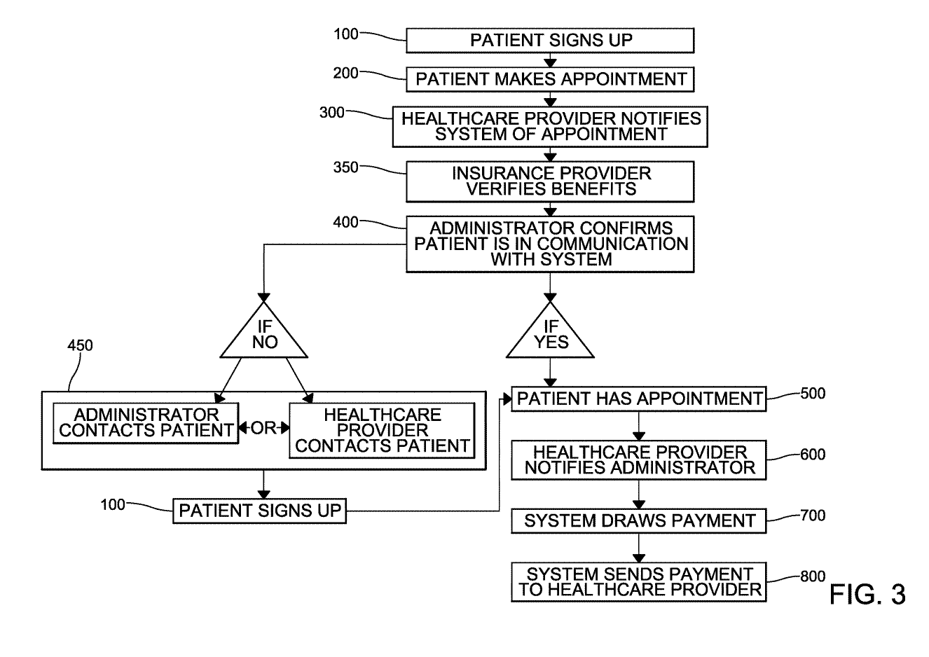

The method of providing payment from the patient 12 to the healthcare provider 14 is shown in FIGS. 2-3. Since the system 10 provides real-time, instantaneous communication between the communication devices 27, 29, 31, 33 through the respective interfaces 26, 28, 30, 32, the order of the steps are exemplary in nature and many of the steps can occur in any order as desired or at a substantially simultaneous or instantaneous period of time.

Initially, in step 100, each of the patient 12, the healthcare provider 14, and the insurance provider 16 will place themselves in communication with the system 10 via the respective interfaces 26, 28, 30 by downloading and/or registering with the system 10. As the patient 12 initially registers with the system 10, the patient 12 will agree to terms in a consent form which will authorize payment contemporaneously to the time of service by a previous designated means. The consent form will be very similar to those consent forms currently being used in the healthcare market today.

In step 200, the patient 12 contacts the healthcare provider 14 to schedule an appointment. The patient 12 may contact the healthcare provider 14 directly, via telephone or other conventional methods, or may contact the healthcare provider 14 through the instant messaging feature of the system 10. In alternate embodiments, the healthcare provider 14 may synchronize one of the RCM program or the EMR system with the system 10, wherein the patient 12 can view and schedule appointments via the patient interface 26.

Once the appointment is scheduled, in step 300, the healthcare provider 14 sends a notification of the upcoming appointment to the system 10. In step 350, the insurance provider 16 is notified from the system 10 of the scheduled appointment and verifies the benefits of the patient 12 through the insurance interface 30. The verification is then sent back to the system 10.

In step 400, the system administrator 18 confirms that the patient 12 is in communication with the system 10. If the patient 12 is not in communication with the system 10, in step 450, either one of the system administrator 18 and the healthcare provider 14 will contact the patient 12, and request the patient 12 register with the system 10 and follow step 100, wherein the patient 12 signs up with the system 10. Once signed up, in step 500, the services are then rendered to the patient 12. In step 600, the healthcare provider 14 notifies the system administrator 18 that the appointment has been completed through the system 10, which may occur automatically by the entering of the Current Procedural Terminology (CPT) code by the healthcare provider 14. It is understood, the healthcare provider 14 may notify the system administrator 18 through the system 10 before or during the rendering of services by the healthcare provider 14.

In step 700, the system 10 then automatically draws an out-of-pocket payment amount of the patient from one of the payment accounts stored in the system 10 by the patient 12 and transfers the payment amount to the healthcare provider 14, in step 800. In step 800, if the healthcare provider 14 collects an excessive payment amount from the patient 12, the system 10 provides the ability for the healthcare provider 14 to credit back the over collected payment amount to one of the payment accounts stored in the system 10.

In one embodiment, the system 10 may deduct a service fee from the payment amount. The system 10 may charge the service fee to the healthcare provider 14 based on a percentage of the total payment amount collected from the patient 12. Alternatively, the service fee may be a flat transaction fee. This service fee covers the ongoing cost of healthcare providers 14 using the system 10.

The initial set-up costs associated with the system 10 the system administrator 18 charges the healthcare providers 14, the insurance providers 16, and/or the patients 12 will be determined based on whichever organization uses the system 10. The system administrator 18 then collects a percentage, to be determined, of the initial set-up fees on a continuing basis.

Upon completion of the transfer of the payment amount, a receipt may be provided to the patient 12 from the system 10. In one embodiment, the receipt is posted electronically to the patient interface 26, wherein the patient 12 can view and/or download the receipt directly from the patient interface 26. In alternate embodiments, the system administrator 18 may send a paper receipt to the patient 12 via mail or electronically via email. The receipt includes a date and time of the appointment and payment and identification of the payment account that the payment amount was drawn from.

The system 10 also allows healthcare providers 14 to set limits on the payment amount, and the ability to set payment options for the patients 12, such as selecting which payment account the payment amount will be drawn from, for example. Payment options may or may not include service fees to be charged to the patient 12.

The system 10 will allow multiple healthcare providers 14, each using different accounting platforms, to access the patient details stored on the memory 22 of the system 10. The system 10 will also allow the patient 12 to track how much was paid to each of the healthcare providers 14. Payment history can then be viewed through the patient interface 26.

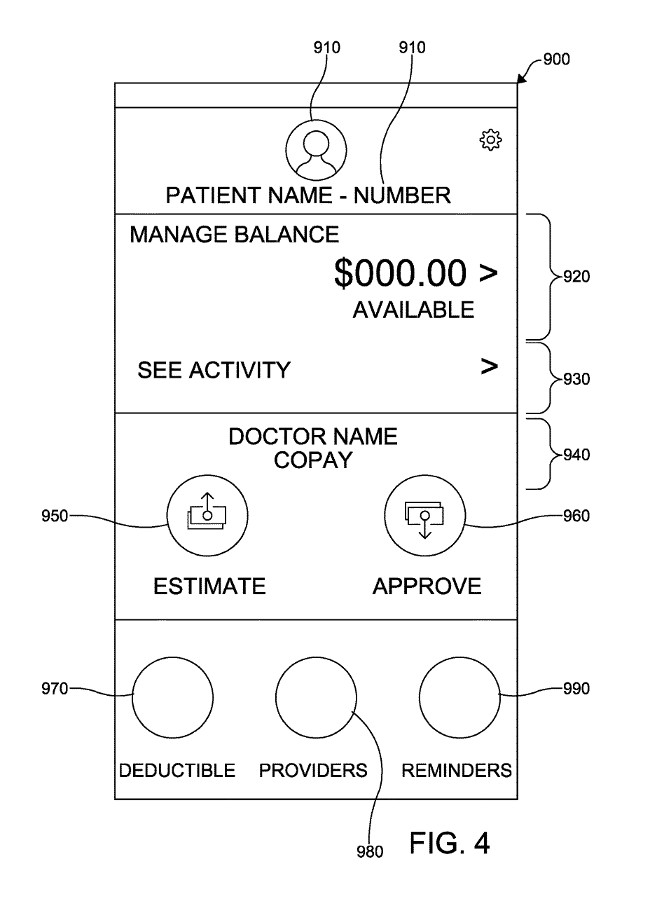

FIG. 4 illustrates the patient interface 26 according to an embodiment of the disclosure. It is understood the provider interface 18, the insurance interface 30, and the administrator interface 32 can be similar, if desired, or can include other features, action controls, or displays pertinent or desired to the respective one of the healthcare provider 14, the insurance provider 16, or the system administrator 18. It is also understood, the patient interface 26 of FIG. 4 is exemplary and can include other information, action controls, and displays, as desired.

According to the embodiment shown, the patient interface 26 includes a main screen 900 that appears when the patient interface 26 is launched. The main screen 900 includes a user indicia 910. The user indicia 910 can be a user identifier or visual identifier of the patient 12, a name of the patient 12, a username of the patient 12, a media such as a picture of the patient 12 or other image chosen by or for the patient 12, and/or other identifying indicia of the patient 12. For example, the user indicia 910 can be the name of the patient 12, an image of the patient, and a patient account number associated with the patient 12 such as shown in FIG. 4.

The patient interface 26 further includes a balance amount action control 920. The balance amount action control 920 can display a balance available in the payment account for payment to the healthcare provider 14. When the balance amount action control 920 is selected by the patient 12, the patient 12 can manage the payment account such as increasing or decreasing an amount of the balance available for payment to the healthcare provider 14 or the account information.

The patient interface 26 can further include an activity action control 930 which, upon selection by the patient 12, can include past activity such as past payments to the healthcare providers 14 and healthcare information or future potential/estimated costs and healthcare information to and of the healthcare provider 14. For example, upon selection of the activity action control 930, a screen (not shown) may appear displaying past services, an amount covered by the insurance of the patient 12, the copayment amount, the coinsurance amount, the deductible amount, any other out-of-pocket amounts, and similar type information. Also, the screen displayed upon selection of the activity action control 930 may display the services rendered by the healthcare provider 14, the name of the healthcare provider 14, and other information as desired.

Additionally, the main screen 900 can include a provider action control 940, wherein upon selection of the provider action control 940, a screen (not shown) is displayed permitting the patient 12 to enter or select identifying information about the scheduled appointment such as the name of the healthcare provider 14 and the services that will be rendered at the appointment. It is understood, the provider action control 940 can be on the screen provided when selecting the activity action control 940.

Once the healthcare provider 14 information is entered or selected an estimate action control 950 and an approve action control 960 can be selected from the main screen 900. According to one embodiment, the estimate action control 950 can estimate the out-of-pocket amount that is required for the specific healthcare provider 14 selected from the provider action control 940. In another embodiment, the estimate action control 950 displays the estimate on a separate screen (not shown). Once the estimate is provided, the patient 12 can choose to approve the amount through the approve action control 960, wherein the estimated amount is provided to the healthcare provider 14 from the account of the patient 12 through the system 10. The payment and remaining balance is communicated to the patient interface 26, the insurance interface 30 and the administrator interface 32, and if required or desired, the provider interface 28.

In an embodiment of the disclosure, as shown, the main screen 900 can include a deductible action control 970, a provider list action control 980, and a reminder action control 990. The deductible action control 970, when selected, displays a screen (not shown) or on the main screen 900 displaying the deductible amount of the patient 12 so the patient 12 is aware of the deductible expenses required for each visit to the healthcare provider 14. The provider list action control 980, upon selection by the patient 12, permits the patient 12 to view on a display screen (not shown) or the main screen 900, in-network providers or out-of-network providers. The display screen or the main screen 900 will obtain costs associated with the healthcare provider 14 and services rendered by the healthcare provider 14 so out-of-pocket costs can be accessed by both the system 10 and the patient 12. In an example, the provider list action control 980 may give contact information to the patient 12 for scheduling or otherwise information on services provided by the healthcare provider 14. The reminder action control 990, upon selection by the patient 12, may alert the patient 12, on a display screen (not shown) or the main screen 900, of upcoming appointments or the need to schedule an appointment based on the health history, age, or recommendations from the healthcare providers 14.

It is understood the patient interface 26 may include a login information, wherein the patient 12 must login to their account with a username and password, for example. It is also understood, the provider interface 28, the insurance interface 30, and the administrator interface 32 may also include login information, if desired.

The system 10 allows the healthcare provider 14 to collect out-of-pocket costs instantaneously at the time of service provided by the healthcare provider 14 to the patient 12, thereby minimizing post-appointment collection efforts and dramatically increasing cash flow to the healthcare provider 14. In most scenarios, the healthcare providers 14 want to collect more out-of-pocket costs such as copayments, especially. The system 10 solves the problem of the patients 12 not paying when payment is due. The system 10 guarantees a payment will be made if a payment is due immediately. Also, certain healthcare providers 14 outsource payment facilities and do not have the resources or time to deal with finances so this system 10 permits the payments to be received at the time of service without burdening the healthcare providers 14. This also advantageously eliminates the need for staff of the healthcare provider 14 to attempt to collect money from the patients 12, and drastically minimizes the collection process after the patient 12 leaves the facility of the healthcare provider 14. Instantaneous collection of payments at the time of service cannot be accomplished with known systems and methods without undesired burden. In known methods and systems, the patient 12, the healthcare provider 14, the insurance provider 16, and the system administrator 18 are not in instant real-time communication. Therefore, it takes a longer amount of time to obtain insurance information, to calculate out-of-pocket costs, to obtain payment. With the system 10 according to the instant disclosure, the obtaining insurance information, calculating out-of-pocket costs, and obtaining payment is instantaneous. Post-service processes and costs are minimized due to the system 10. For example, the system 10 minimizes invoices being sent through mail or email and insurance processing at a time after the services are rendered

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A system of automated payment from a patient to a healthcare provider, comprising:
a host including a memory and a processor;
a plurality of communication devices in communication with the host;
a patient interface associated with the patient downloadable on a first one of the plurality of communication devices, the patient interface including a payment account information of the patient and configured to distribute to the host the payment account information; and
a provider interface associated with the healthcare provider providing healthcare to the patient downloadable on a second one of the plurality of communication devices, the provider interface configured to receive the payment account information of the patient from the host to process a payment at a time of service for services provided to the patient from the healthcare provider.

2. The system of claim 1, further comprising an insurance interface associated with an insurance provider of the patient downloadable on a third one of the plurality of communication devices, the insurance interface including insurance information associated with an insurance of the patient, the insurance interface providing to the patient interface the insurance information through the host.

3. The system of claim 2, wherein the insurance information includes at least one of a benefit explanation of the patient, a claim status of the patient, and a deductible amount of the patient.

4. The system of claim 2, further comprising an administrator interface associated with an administrator of the system downloadable on a fourth one of the plurality of communication devices, the administrator interface providing real-time communication between the patient interface, the provider interface, and the insurance interface through the host.

5. The system of claim 4, wherein the memory stores patient information, and wherein the patient information is the payment account information, contact details of the patient, and insurance details of the patient received from at least one of the patient interface, the provider interface, the insurance interface, and the administrator interface.

6. The system of claim 1, wherein the patient interface includes feedback data from a patient about the healthcare provided by the healthcare provider, the feedback data distributable to at least one of the administrator and the healthcare provider through the host.

7. The system of claim 1, wherein the patient interface includes a user indicia associated with the patient.

8. The system of claim 1, wherein the patient interface further includes a balance amount action control, the balance amount action control displaying a balance available for payment to the healthcare provider from the patient.

9. The system of claim 1, wherein the patient interface includes an activity action control configured to display at least one of past payments to the healthcare provider, healthcare information, and estimated costs for the healthcare provider.

10. The system of claim 1, wherein the patient interface includes a provider list action control permitting the patient to select the healthcare provider.

11. The system of claim 1, wherein the patient interface includes an estimate action control and an approve action control, the estimate action control estimating an amount of the payment due to the healthcare provider and the approve action control permitting distribution of the payment account information to the host to process the payment to the healthcare provider.

12. The system of claim 1, wherein a receipt is transferred to the patient interface through the host.

13. A method of providing a payment from a patient to a provider comprising the steps of:
providing a system including a host having a memory for storing information and a processor, the host in communication with a plurality of communication devices, a first one of the communication devices having a downloadable patient interface associated with the patient receiving services from the healthcare provider, a second one of the communication devices having a downloadable provider interface associated with the healthcare provider, and a third one of the communication devices having a downloadable administrator interface associated with an administrator of the system, the patient interface, the provider interface, and the administrator interface providing real-time communication between the plurality of communication devices;
creating a payment account with the patient interface by the patient;
transferring the payment with the patient interface to the administrator interface through the host;
transferring the payment to the provider interface from the administrator interface through the host; and
processing the payment through the provider interface at a time of the services.

14. The method of claim 13, further comprising the step of registering with the system by providing a login credential, a patient information, an insurance information, and a consent through the patient interface by the patient.

15. The method of claim 13, further comprising the step of scheduling an appointment with the healthcare provider through the patient interface.

16. The method of claim 15, further comprising the steps of:
sending a notification of the scheduled appointment to the administrator interface through the host;
confirming whether the patient is registered with the system through the administrator interface; and
contacting the patient by one of the administrator and the healthcare provider to register with the system, if the patient is not registered with the system.

17. The method of claim 13, further comprising the step of sending a notification the services from the healthcare provider to the patient were rendered to the administrator interface through the host using the provider interface.

18. The method of claim 13, further comprising the step of deducting a service fee from the payment through the system.

19. A method of providing a payment from a patient to a provider comprising the steps of:
providing a system including a host having a memory for storing information and a processor, the host in communication with a plurality of communication devices, a first one of the communication devices having a downloadable patient interface associated with a patient receiving services from a healthcare provider, a second one of the communication devices having a downloadable provider interface associated with the healthcare provider, a third one of the communication devices having a downloadable administrator interface associated with an administrator of the system, and a fourth one of the communication devices having a downloadable insurance interface associated with an insurance provider, the patient interface, the provider interface, the insurance interface, and the administrator interface providing real-time communication between the plurality of communication devices;
signing up with the system by the patient through the patient interface;
creating a payment account with the patient interface by the patient;
transferring the payment with the patient interface to the administrator interface through the host;
transferring the payment to the healthcare provider interface from the administrator interface through the host; and
processing the payment instantaneously through the provider interface at a time of the services.

20. The method of claim 19, further comprising the step of estimating a cost of the services prior to the services being rendered through the patient interface.
